(19) United States
(12) Patent Application Publication
(10) Pub. No.: US 2016/0084693 A1
(43) Pub. Date: Mar. 24, 2016

(54) CONSUMPTION METER WITH SELECTABLE LEGAL REGISTERS

(71) Applicant: KAMSTRUP A/S, Skanderborg (DK)

(72) Inventors: Søren Lang, Skanderborg (DK); Mads Erik Lund Jensen, Rødkærsbro (DK)

(21) Appl. No.: 14/889,097

(22) PCT Filed: May 7, 2014
(86) PCT No.: PCT/DK2014/050129

§ 371 Date: Nov. 4, 2015

(30) Foreign Application Priority Data
May 8, 2013 (EP) 13167067.1

(51) Int. Cl. G01F 15/075

(52) U.S. Cl. CPC G01F 15/075

(57) ABSTRACT

The present invention relates to a consumption meter for measuring consumption data of either a hot or a cold liquid supplied to a consumer site (2). The consumption meter comprises a flow meter unit (5) arranged for mount at either an inlet side (3) or an outlet side (4) of the consumer site, and arranged for measuring a flow quantity of the supplied liquid; an inlet temperature sensor (6) for measuring an inlet temperature of the supplied liquid medium, and an outlet temperature sensor (7) for measuring an outlet temperature of the supplied liquid medium; a calculator unit (8) configured to determine consumption values based on the flow quantity, the inlet temperature and the outlet temperature. The consumption meter comprises at least two legally verified consumption registers (R1, R2) for storing consumption values verified for billing. Each of the legally verified consumption registers are associated with an operational state of the consumption meter, so that the consumption meter is capable of measuring legally verified consumption data for each of the at least two operational states. The operational state is determined at the consumer site from an input.

### FIELD OF THE INVENTION

The present invention relates to a consumption meter, such as an ultrasonic flow meter, for measuring consumption data of either a hot or a cold liquid supplied to a consumer site. The present invention also relates to a method for installation of a consumption meter.

### BACKGROUND OF THE INVENTION

Utilities supplied to an end-user site are in many situations metered at the end-user site by a consumption meter for billing purposes. For example, supplied district heating is metered by a heat meter whereas supplied district cooling is metered by a cooling meter. Consumption meters of the heat meter and cooling meter types often operate as energy meters for metering the supplied energy. An energy meter normally comprises a flow meter unit, two temperature sensors and a calculator unit, where the flow meter unit is arranged to measure the amount of supplied liquid, and the temperature sensors are arranged to measure the inlet and outlet temperatures. Based on the flow measurement and the temperature measurement, the calculator unit calculates the amount of energy consumed. Many energy meters can be used both as heat meters and as cooling meters, or even as combined meters.

Consumption meters which are used for billing purposes are subdued to regulatory demands. Such regulatory demands may be demands to the precision of the measurements. Regulatory demands require that meters are individually tested and verified according to national or international regulations before users can be billed based on a measured consumed amount.

In the verification test, the consumption meter is tested and verified for a given use and installation, e.g. whether it operates as a heat meter or as a cooling meter, as well as the specific installation configuration, e.g. whether it is to be mounted at the inlet side or at the outlet side of a consumer site. After verification, the consumption meter cannot legally be used in a different manner than the manner for which it was verified. One consequence is that already at the time of the order of the consumption meter, is it required to know the precise installation configuration. And moreover, in the situations where a meter is installed inconsistently with its verification, either a new meter should be installed or the meter should be remounted for re-verification for the specific installation configuration, even if the meter in principle can measure the consumption values in the given installation configuration.

In EP 2 000 788 Al in the name of Kamstrup, an energy calculator is disclosed which in connection with the installation is arranged to detect installation errors to alert the installer already during installation, so that any errors can be corrected while the installer is present at the consumer site.

In EP 1 975 583 A1 in the name of Landis+Gyr, an energy meter is disclosed which comprises a main data memory for saving correctly determined hot or cold volumes, and secondary data memories for saving incorrectly determined hot or cold volumes relating to known types of installation errors. While incorrectly determined hot or cold volumes values are determined and saved, a meter exchange or re-verification is needed if the meter verification does not match the use or installation configuration.

In U.S. Pat. No. 4,245,501 in the name of Wilgood Corporation, a combined heat and cooling meter is disclosed which comprises a heating and a cooling register, monitoring means for determining flow and temperature of the fluid supplied, and automatic switching means for connecting, during operation, the output of the monitoring means to either of the registers, whether the meter is operated in a heating or cooling environment.

In DE 10 2010 011 272 A2 in the name of Hydrometer, an energy meter is disclosed which comprises a display that shows the current operational state, by simultaneously displaying flow direction as well as whether heat energy or cooling energy is measured. Erroneous installation can be detected on site, however, a meter exchange or re-verification is needed if the meter verification does not match the use or installation configuration.

### SUMMARY OF THE INVENTION

It would be advantageous to achieve a consumption meter which is capable of measuring legally verified consumption data for more than one operational state at the consumer site, in particular for more than one operational state at the consumer site relating to the consumption meter being mounted at the inlet side or the outlet side of a consumer site. In general, the invention preferably seeks to mitigate, alleviate or eliminate one or more of the above mentioned disadvantages singly or in any combination.

Accordingly, in a first aspect, there is provided a consumption meter arranged for fixed installation at a consumer site for measuring consumption data of either a hot or a cold supplied liquid to the consumer site, the meter comprises:
a flow meter unit arranged for mount at either an inlet side or an outlet side of the consumer site, and arranged for measuring a flow quantity of the supplied liquid;
an inlet temperature sensor for measuring an inlet temperature of the supplied liquid, and an outlet temperature sensor for measuring an outlet temperature of the supplied liquid;
a calculator unit configured to determine consumption values based on the flow quantity, the inlet temperature and the outlet temperature, wherein the calculator unit comprises at least a first and a second legally verified consumption registers for storing consumption values verified for billing, the first legally verified consumption register being associated with a first operational state of the consumption meter being mounted at the inlet side of the consumer site and the second legally verified consumption register being associated with a second operational state of the consumption meter being mounted at the outlet side of the consumer site, so that the consumption meter is capable of measuring legally verified consumption data for each of the at least first and second operational states;
   wherein the consumption meter is arranged for receiving an input and to set the operational state of the consumption meter based on the input in accordance with the arrangement of the flow meter unit at the consumer site, so as to store consumption values in the legally verified register associated with the set operational state of the consumption meter.

The present invention provides a consumption meter where the calculator unit comprises at least two legally verified consumption registers for storing consumption values verified for billing, and where each legally verified consumption register is associated with an operational state of the consumption meter. Thus the calculator comprises at least a first and a second legally verified consumption registers for storing consumption values verified for billing, the first legally verified consumption register being associated with a first operational state of the consumption meter, in which the consumption meter is adapted for being mounted at the inlet side of the consumer site, and the second legally verified consumption register being associated with a second operational state of the consumption meter, in which the consumption meter is adapted for being mounted at the outlet side of the consumer site, so that the consumption meter is capable of measuring legally verified consumption data for each of the at least first and second operational states. In this manner, the consumption meter is capable of measuring legally verified consumption data for each of the at least two operational states.

The consumption meter of the present invention is arranged for receiving an input and to have set the operational state in accordance with the arrangement of the consumption meter at the consumer site. Upon receiving the input and setting the operational state, the register where consumption values for billing is stored, is in turn selected.

The advantage of this is at least twofold: One advantage relates to that the installer in one case can bring along to a consumer site a consumption meter which is not finally configured for the specific operational state, however, which may be configured at the consumer site. With this case the installer needs thus not in advance have full information as to whether the consumption meter at the consumer site is supposed to be installed at the inlet side or the outlet side of the installation. The installer therefore does not need to stock meters for all types of consumer installation configuration. Likewise, unconfigured consumption meters may be produced, which, upon receipt of an order, may be finally configured at the factory site for their specific application.

Another advantage relates to that in the event an erroneous installation nevertheless should occur, a meter exchange or re-verification can in at least some situations be avoided.

In the context of the present invention, “a legally verified consumption register” should be understood as a register, which is tested and verified for a given use, and which is therefore legally qualified for being used for billing purpose within the framework of such use.

Further in the context of the present invention, “an operational state of the consumption meter” shall mean the specific use of the consumption meter, i.e. as a inlet side mounted meter or as an outlet side mounted meter.

Moreover, a “register being associated with an operational state” shall mean that the register is tested and verified for being used for billing purposes when the meter is used in the specific use.

Also in the context of the present invention, “the consumption meter being mounted at the inlet side of the consumer site” and “the consumption meter being mounted at the outlet side of the consumer site”, shat means the consumption meter is mounted in the inlet supply line and the outlet supply line, respectively, of the consumer site.

Thus, according to the invention, the consumption meter involves at least two registers, which are legally verified registers, and which may be selected, e.g. by an installer at the consumer site, depending on the specific operational state of the consumption meter, i.e. the specific use of the consumption meter in an inlet side or outlet side of the consumer site.

Compared to consumption meters of the prior art, the consumption meter of the present invention involves a plurality of registers, which are legally verified for use with these different operational states, each legally verified register being associated with a specific operational state, and which is adapted to being selected upon receipt of an input to the consumption meter.

Although consumption meters of the prior art may involve a plurality of registers as well, such registers are not legally verified. Thus the secondary data memories of EP 1 975 583 A1 are not legally verified. Also, EP 1 975 583 A1 does not involve that the consumption meter is adapted for selection of a specific legally verified register to be used depending on the actual operational state of the consumption meter.

Likewise, the energy meter of U.S. Pat. No. 4,245,501 is not adapted to being selectively arranged at the inlet side or outlet side of the consumer site and to operate therein in as a legally verified meter.

In addition to the legally verified consumption registers, a number of non-legally verified consumption registers may also be present with the consumption meter for various uses, such as data logging. Nevertheless, additional legally verified consumption registers may also be implemented with the consumption meter.

Advantageously, the flow meter unit is an ultrasonic flow meter arranged to measure a flow rate of the supplied liquid. In general, however, the flow meter unit may be any kind of suitable flow meter, such as a mechanical meter, e.g. an impeller-type meter, a magnetic inductive meter, etc.

In a second aspect, the invention relates to a method of installation a consumption meter. Thus, with this aspect is provided a method for installation of a consumption meter arranged for fixed installation at a consumer site for measuring consumption data of either a hot or a cold supplied liquid to the consumer site, wherein the meter comprises:
a flow meter unit arranged for mount at either an inlet side or an outlet side of the consumer site, and arranged for measuring a flow quantity of the supplied liquid;
an inlet temperature sensor for measuring an inlet temperature of the supplied liquid, and an outlet temperature sensor for measuring an outlet temperature of the supplied liquid;
a calculator unit configured to determine consumption values based on the flow quantity, the inlet temperature and the outlet temperature, wherein the calculator unit comprises at least a first and a second legally verified consumption registers for storing consumption values verified for billing, the first legally verified consumption register being associated with a first operational state of the consumption meter being mounted at the inlet side of the consumer site, and the second legally verified consumption register being associated with a second operational state of the consumption meter being mounted at the outlet side of the consumer site; and
   wherein the method comprises:
arranging the flow meter unit at either an inlet side or an outlet side of the consumer site;
providing an input to be received by the consumption meter, to select, between the at least first and second operational states of the consumption meter, the operational state of the consumption meter in accordance with the arrangement of the flow meter unit at the consumer site so as to store consumption values in the legally verified register associated with the selected operational state of the consumption meter.

Further embodiments, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 illustrates elements of a consumption meter arranged for fixed installation at a consumer site for the two situations of inlet mounted and outlet mounted flow meter units; and

FIG. 2 is a schematic of a calculator unit.

### DESCRIPTION OF EMBODIMENTS

Consumption meters for charging purposes are subjected to strong legal requirements regarding their function to ensure that the basic meter function works in a well-defined manner. A consumption meter must be approved by the authorities in order to be legally cleared for charging purposes. An important aspect in the approval process is that the meter is tested to measure consumption values within a specific precision, and that certain registers, i.e. memory allocations for electronic meters, are made in such a way that once the consumption value is stored in such a register, a sufficient high confidence can be assigned to this value, so that it can be used as a base for billing. The registers which are made to fulfil the requirement to be able to obtain an authority approval are referred to as legally verified consumption registers.

A legally verified consumption register has undergone a verification test with respect to the values stored therein. In the verification test, the consumption meter is subdued to known test conditions, and the resulting values stored in the consumption register are examined for compliance with the ideal values which follow from the test conditions. The verification test may be a split test, where different parts of the consumption meter are tested separately, or it may be a unified test, where the assembled consumption meter is tested as an assembly. In the unified test, a known volume of liquid at a given temperature is run through the flow meter unit and the determined consumption values are stored in the register under verification. The values stored in the consumption register under verification are compared with the known values that follow from the known test conditions. If the stored values comply with the test criteria, the consumption register is verified for the operational state for which it was tested. In a verification process each consumption meter is tested for compliance, and possibly calibrated if necessary. The verification is performed by or in corporation with a certifying organisation.

The verification test may be combined with a type test where the type of the consumption meter is subdued to a comprehensive test.

A consumption meter for measuring a hot or a cold liquid supplied to the consumer site in connection with district heating or district cooling is mounted in a fixed installation at the consumer site. Typically the flow meter unit and the temperature sensors are mounted in line with the supply pipeline.

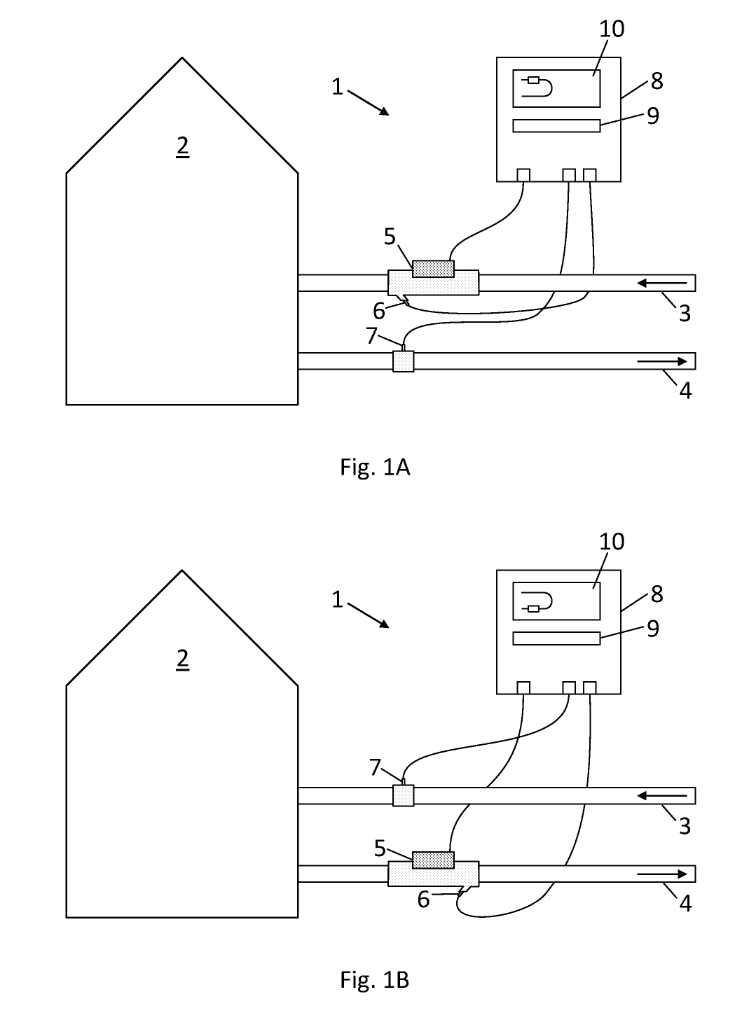

Embodiments of consumption meters in accordance with the invention are illustrated in FIGS. 1A and 1B.

FIG. 1A illustrates elements of a consumption meter arranged for fixed installation at a consumer site. The consumption meter is illustrated as a collection of separate interconnected elements, however, at least some of the elements may be integrated. In particular, the calculator unit and the flow meter unit may be integrated.

The figure illustrates a consumer site to which a supply line 3, 4 of hot or cold liquid is present in order for providing district heating or district cooling to a consumer 2, such as a household or a business premise. The supply line comprises an inlet line 3 and an outlet line 4. In FIG. 1A, a flow meter unit 5 is mounted in the inlet supply line 3 for measuring a flow quantity of the supplied liquid. The flow quantity is typically the supplied volume of the supplied liquid, but could also be such values as flow speed. The consumption meter further comprises an inlet temperature sensor 6 for measuring an inlet temperature, Tᵢₙ, of the supplied liquid medium, and an outlet temperature sensor 7 for measuring an outlet temperature, Tₒᵤₜ, of the supplied liquid medium. In connection with district heating, the liquid is supplied at a relatively high temperature, such as between 70 and 90 degrees Celsius and cooled down due to the energy release at the consumer site to heat the consumer site. Consequently, there is a temperature difference, ΔT, between the inlet temperature and the outlet temperature.

The figure further shows a calculator unit 8 configured to determine consumption values based on the flow quantity, the inlet temperature and the outlet temperature. To this end, the calculator unit comprises inputs from these elements.

FIG. 1B is similar to FIG. 1A, except that the flow meter unit 5 is mounted in the outlet supply line 4 for measuring the flow quantity of the supplied liquid at the outlet.

FIG. 1A and FIG. 1B illustrate two different operational states. The operational state of FIG. 1A is that of an inlet mounted flow meter unit, whereas the operational state of FIG. 1B is that of an outlet mounted flow meter unit. The operational states are different since the liquid temperatures are different in the inlet and in the outlet due to the energy consumption by the consumer. For a heat meter installation, the inlet temperature is higher than the outlet temperature, whereas for a cooling meter installation it is opposite.

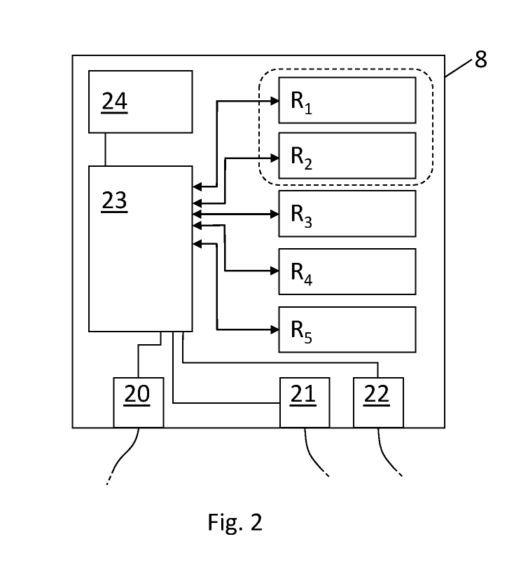

FIG. 2 is a schematic of the calculator unit 8. The calculator unit 8 is a computing unit which is capable of obtaining sensor readings, in this case at least the two temperatures and the flow quantity, and based on these readings to calculate consumption values. FIG. 2 schematically shows elements of an embodiment of a calculator unit. The figure shows sensor connections 20 for the flow value, and 21, 22 for the two temperature readings, as well as a computing unit 23, typically in the form of an integrated circuit comprising one or more microprocessors. Moreover, a communication unit 24 is shown for remote reading of the consumption meter. Other components may be present as well.

Additionally, the calculator unit 8 comprises a number of registers for storing various values based on sensor readings. In the illustrated exemplary embodiment, the five registers, R₁ to R₅, are shown.

In the illustrated embodiment, the calculator unit comprises two legally verified consumption registers, R₁ and R₂, for storing consumption values verified for billing. The registers R₃ to R₅ are not legally verified, which means that values stored therein are not authorized for billing. Such registers may be used e.g. for data logging.

In the example R₁ is a legally verified consumption register associated with the operational state of an inlet mounted heat meter, whereas R₂ is a legally verified consumption register associated with the operational state of an outlet mounted heat meter. The use of at least two legally verified consumption registers associated with these operational states of the consumption meter has the advantage that prior to mounting of the consumption meter, the installer does not need to know whether the consumption meter should be mounted in the inlet or in the outlet side. If the meter is a replacement meter, the mount position is typically that of the former meter, whereas for a newly installed meter the mount position may be determined by such aspects as where the meter fits best in the pipeline. A consumer often does not have knowledge about the proper installation position, as such knowledge requires a certain level of expertise, and therefore cannot provide such information to the installer in advance. By use of the present invention, however, there is no need beforehand to know the installation position, since the consumption meter is capable of measuring legally verified consumption data for each of the operational states.

Instead, the consumption meter is arranged for receiving an input, e.g. at the consumer site, and to have set the operational state of the consumption meter based on this input. The specific legally verified register for storage of the consumption values for billing may thereby be selected on-site.

The input may be based on an input received at a user interface 9. For example, the installer may have access to a setup menu, in which it is possible to define the operational state of the consumption meter.

The input may also be received or calculated by the calculator in connection with an operational mode selection routine which is performed after installation. This has the advantage that the installer does not need to spend time on configuring this aspect of the meter.

The input may be a measured input which fulfils a selection criterion and which is received by the calculator unit. In embodiments, the selection criterion may be based on a temperature reading.

In embodiments, the first of the temperature sensors 6 is mounted in a receiver site comprised in the flow meter unit housing, and the second of the temperature sensors 7 is mounted in a receiver unit separate from the flow meter housing. The separate temperature sensor receiver unit may be mounted in the other supply line than the one of the flow meter unit.

In such embodiment, the temperature reading can be used to determine the mount position. In the given embodiment where the flow meter unit is a heat meter, the selection criterion may be that if the temperature measured at the flow meter housing is higher than the temperature measured separate from the flow meter housing, the flow meter is inlet mounted. Likewise, if the temperature measured at the flow meter housing is lower than the temperature measured separate from the flow meter housing, the flow meter is outlet mounted.

Thus, according to this embodiment of the invention, the input to be received is received by the calculator unit and is based on a temperature difference between the inlet temperature and the outlet temperature.

Also the absolute temperature may be used. For example, if the temperature at the flow meter housing is higher than 50 degrees Celsius, the meter may be determined to be inlet mounted.

Thus, according to this embodiment of the invention, the input to be received is received by the calculator unit and is based on a temperature of the supplied liquid.

Once the operational state is determined or selected, it may be shown in a display of the consumption meter. It may be an authority requirement that the operational state is shown in the display.

In FIG. 1A and 1B the flow meter unit housing is illustrated to comprise a receiver site for a temperature sensor. In general, the temperature probes may both be mounted in separate receiver units, one unit for each supply line.

According to the invention, the consumption meter comprises two legally verified consumption registers for a heat meter, where the first legally verified consumption register is related to inlet mount of the consumption meter and the second legally verified consumption register is related to outlet mount of the consumption meter.

In other embodiments, the consumption meter may comprise that the legally verified consumption registers are registers for heat energy and/or for cooling energy.

Also, in alternative embodiments of the invention, the legally verified consumption registers are registers for flow of supplied liquid in a first flow direction, and for flow of the supplied liquid in a second, opposite flow direction, or they are registers for flow of supplied liquid registered at a first pulse number of the flow meter unit, and for flow of supplied liquid registered at a second pulse number of the flow meter unit.

With the latter case, the consumption meter may be configured with respect to a pulse number as received from e.g. a mechanical flow meter unit, and in turn reconfigured in case the flow meter unit is replaced or changed.

In another embodiment, the consumption meter may comprise at least four legally verified consumption registers for storing consumption values verified for billing: A first legally verified consumption register for heat energy in inlet mount, and a second legally verified consumption register for heat energy in outlet mount, as well as a third legally verified consumption register for cooling energy in inlet mount, and a fourth legally verified consumption register for cooling energy in outlet mount. This is summarized in the following table together with the formulas for the energy calculations:

| | Inlet mount | Outlet mount |
|---|---|---|
| Heat | T_{M} − T_{O} > 0 | T_{M} − T_{O} < 0 |
| | R₁ₕ = V (T_{M} − T_{O}) k_{IN} | R₂ₕ = V (T_{O} − T_{M}) k_{OUT} |
| Cooling | T_{M} − T_{O} < 0 | T_{M} − T_{O} > 0 |
| | R_{1c} = V (T_{O} − T_{M}) k_{OUT} | R_{2c} = V (T_{M} − T_{O}) k_{IN} |

In this table, T_{M} and Tₒ refer to the temperature at the flow meter unit as measured by temperature sensor 6 and to the temperature as measured by the receiver separate from the flow meter unit and as measured by temperature sensor 7, respectively, V is the determined volume V as measured by the flow meter unit, kin and kᵢₙ and kₒᵤₜ are correction factors which accounts for the physical differences among hot and cold liquid, such as density and specific heat capacity. The energy values are referred to by the respective registers R₁ₕ, R_{1c}, R₂ₕ, and R_{2c}, which are all legally verified registers.

The above embodiment is advantageous for an asymmetric flow meter. In this context, an asymmetric flow meter is a flow meter which needs to operate in a specific orientation with respect to the flow direction, e.g. due to a flow conditioner inserted in the inlet to remove or reduce vortexes or by other means improve the flow profiles, or due to a grid inserted in the inlet to block debris in the flowing liquid. For such a flow meter, four registers cover many important applications.

In an embodiment, the consumption meter is arranged to perform the energy calculation and store the result only in the register which is associated with the operational state as determined from the input. For example, if the operational state is selected to be an inlet mounted heat meter, values are stored only in the legally verified register R₁, whereas neither the legally verified register R₂ nor any other registers are used.

In another embodiment, in addition to storing consumption values for billing only in the register associated with the determined operational state, consumption data are stored in at least one more legally verified consumption register of the at least two legally verified consumption registers which is not associated with the determined operational state. Thus both of the first and the second legally verified consumption registers are arranged for storage of consumption values associated with the selected operational state of consumption meter. For example, in addition to storing values in the register R₁, values are also stored in R₂. In general, the energy calculation may be performed for all legally verified registers and stored therein, irrespectively of the determined operational state. The operational state is nevertheless used for determine which register that should be used for billing.

An advantage of this embodiment is that in the event that the consumption meter should register an erroneous operational state, e.g. due to an erroneous user input or an installation error, the consumption value for the correct operational state may thereby be stored in the relevant register. In such situation, it may be possible merely to correct the operational state of the meter, instead of exchanging it or re-verifying it. For example if an inlet mounted heat meter is erroneously provided with the operational state of an outlet mounted heat meter, it will register values for billing in R₂. The correct formula is never the less the one for R₁. However, since R₁ is also a legally verified register, the operational state can be corrected, and thereby the legally verified register can be corrected without exchange or re-verification.

Likewise, in an embodiment of the invention, the calculator unit comprises at least a third legally verified consumption register associated with the first or second operational state, wherein the consumption meter is arranged for storage of consumption values in the legally verified register associated with the selected operational state of the consumption meter as well as in the third legally verified consumption register.

In further embodiments, at least one of the legally verified consumption registers is imposed with an access constraint so that data can only be stored in the register upon fulfilment of the access constraint, and otherwise disregarded. For example, an access constraint may be that the temperature difference should be either positive or negative.

In the embodiment with four legally verified consumption registers, the temperature difference alone cannot be used to select the operational state, since an inlet mounted heat meter and an outlet mounted cooling meter has the same temperature difference, and likewise with an outlet mounted heat meter and an inlet mounted cooling meter. In this situation, the mount position may be determined from the temperature difference whereas whether the meter is a heat meter or a cooling meter is determined from a user input or an absolute temperature reading.

In embodiments the flow meter may function correctly irrespectively of the flow direction. In such situation the meter may comprise at least one legally verified consumption register for storing consumption values verified for billing of the supplied liquid that flows in a direction which is opposite the operating flow direction. In general, the consumption meter may comprise two times the number of the various register. For example, the above table may comprise eight possibilities, one for each of the two flow directions.

Also in embodiments the calculator unit comprises at least a third legally verified consumption register associated with the first or second operational state, wherein the consumption meter is arranged for storage of consumption values in the legally verified register associated with the selected operational state of the consumption meter or in the third legal legally verified consumption register based on a storage criterion.

Thus two or more legally verified registers are associated with the operational state so that consumption values for billing are stored in at least one of the two or more associated registers based on a storage criterion. For example, for a combined heat and cooling meter which is arranged for metering heat energy during winter, and cooling energy during summer, the operational state may be set to be a combined meter. This operational state may be associated with four legally verified registers, and depending upon whether the meter is inlet mounted or outlet mounted, R₁ₕ and R_{1c}, or R₂ₕ and R_{2c} may be selected. A storage criterion may be selected as to whether heating energy or cooling energy is calculated. The storage criterion may be the temperature difference, the inlet temperature or other appropriate criteria.

The consumption meter may be arranged for receiving the input while being in a set up mode. Thus, in an embodiment, the consumption meter may be able to operate in a setup mode where it can be arranged to operate in any of the at least two operational states. In the setup mode, the operational state can be selected from a group of possible operational states in accordance with the situation for which the meter has been verified. Upon termination of the setup mode, the consumption meter enters an operational mode, where it operates in accordance with the selected operational state.

It may be advantageous to implement, that once the setup mode has been terminated, the operational state can only be changed by breaking a physical seal of the consumption meter. In this manner, only authorized persons can change a selected operational state of the meter.

The setup mode may in an embodiment be terminated by the installer. Advantageously it is however terminated automatically by detecting a flow of a preselected amount of the supplied liquid, such as when more than 1 litre, 10 litres or another appropriate amount of liquid has flown through the meter.

Also, according to an embodiment of the invention, the consumption meter is further arranged for, in case an operational state of the consumption meter inconsistent with the installation of the flow meter unit was previously set, receiving an additional input at the consumer site and to set the operational state of the consumption meter based on the input in accordance with the arrangement of the flow meter unit at the consumer site, so as to store consumption values in the legally verified register associated with the set operational state of the consumption meter.

With the second aspect of the invention the method for installation of a consumption meter may further comprise that both of the first and the second legally verified consumption registers are used for storage of consumption values associated with the selected operational state of the consumption meter.

Also the method may comprise that the calculator unit comprises at least a third legally verified consumption register associated with the first or second operational state so as to store consumption meter consumption values in the legally verified register associated with the selected operational state of the consumption meter as well in the third legally verified consumption register.

Further, in embodiments of the present invention, a method is provided for installation of a consumption meter arranged for fixed installation at a consumer site for measuring consumption data of either a hot or a cold supplied liquid to the consumer site, wherein the meter comprises:
a flow meter unit arranged for mount at either an inlet side or an outlet side of the consumer site, and arranged for measuring a flow quantity of the supplied liquid;
an inlet temperature sensor for measuring an inlet temperature of the supplied liquid, and an outlet temperature sensor for measuring an outlet temperature of the supplied liquid;
a calculator unit configured to determine consumption values based on the flow quantity, the inlet temperature and the outlet temperature, wherein the calculator unit comprises at least a first and a second legally verified consumption registers for storing consumption values verified for billing, the first legally verified consumption register being associated with a first operational state of the consumption meter being mounted at the inlet side of the consumer site and the second legally verified consumption register being associated with a second operational state of the consumption meter being mounted at the outlet side of the consumer site; and
   wherein the method comprises:
arranging the flow meter unit at either an inlet side or an outlet side of the consumer site;
providing an input to be received by the consumption meter, to select, between the at least first and second operational states of the consumption meter, an operational state of the consumption meter inconsistent with the arrangement of the flow meter unit;
observing that the selection of the operational state of the consumption meter is inconsistent with the installation of the flow meter unit at the consumer site; and
providing an additional input to the consumption meter, to be received by the consumption meter at the consumer site, to select, between the at least first and second operational states of the consumption meter, the operational state of the consumption meter in accordance with the arrangement of the flow meter unit at the consumer site so as to store consumption values in the legally verified register associated with the selected operational state of the consumption meter.

Also a consumption meter is provided, which is arranged for fixed installation at a consumer site for measuring consumption data of either a hot or a cold supplied liquid to the consumer site, the meter comprises:
a flow meter unit arranged for mount at either an inlet side or an outlet side of the consumer site, and arranged for measuring a flow quantity of the supplied liquid;
an inlet temperature sensor for measuring an inlet temperature of the supplied liquid, and an outlet temperature sensor for measuring an outlet temperature of the supplied liquid;
a calculator unit configured to determine consumption values based on the flow quantity, the inlet temperature and the outlet temperature, wherein the calculator unit comprises at least a first and a second legally verified consumption registers for storing consumption values verified for billing, the first legally verified consumption register being associated with a first operational state of the consumption meter for metering heating energy and the second legally verified consumption register being associated with a second operational state of the consumption meter for metering cooling energy, so that the consumption meter is capable of measuring legally verified consumption data for each of the at least first and second operational states;
   wherein the consumption meter is arranged for receiving an input and to set the operational state of the consumption meter based on the input in accordance with the arrangement of the flow meter unit at the consumer site, so as to store consumption values in the legally verified register associated with the set operational state of the consumption meter.

Further, a consumption meter is provided, which is arranged for fixed installation at a consumer site for measuring consumption data of either a hot or a cold supplied liquid to the consumer site, the meter comprises:
a flow meter unit arranged for mount at either an inlet side or an outlet side of the consumer site, and arranged for measuring a flow quantity of the supplied liquid;
an inlet temperature sensor for measuring an inlet temperature of the supplied liquid, and an outlet temperature sensor for measuring an outlet temperature of the supplied liquid;
a calculator unit configured to determine consumption values based on the flow quantity, the inlet temperature and the outlet temperature, wherein the calculator unit comprises at least a first and a second legally verified consumption registers for storing consumption values verified for billing, the first legally verified consumption register being associated with a first operational state of the consumption meter for metering flow of supplied liquid in a first flow direction and the second legally verified consumption register being associated with a second operational state of the consumption meter for metering flow of the supplied liquid in a second, opposite flow direction, so that the consumption meter is capable of measuring legally verified consumption data for each of the at least first and second operational states;
   wherein the consumption meter is arranged for receiving an input and to set the operational state of the consumption meter based on the input in accordance with the arrangement of the flow meter unit at the consumer site, so as to store consumption values in the legally verified register associated with the set operational state of the consumption meter.

Eventually, a consumption meter is provided, which is arranged for fixed installation at a consumer site for measuring consumption data of either a hot or a cold supplied liquid to the consumer site, the meter comprises:
a flow meter unit arranged for mount at either an inlet side or an outlet side of the consumer site, and arranged for measuring a flow quantity of the supplied liquid;
an inlet temperature sensor for measuring an inlet temperature of the supplied liquid, and an outlet temperature sensor for measuring an outlet temperature of the supplied liquid;
a calculator unit configured to determine consumption values based on the flow quantity, the inlet temperature and the outlet temperature, wherein the calculator unit comprises at least a first and a second legally verified consumption registers for storing consumption values verified for billing, the first legally verified consumption register being associated with a first operational state of the consumption meter for metering flow of supplied liquid registered at a first pulse number of the flow meter unit and the second legally verified consumption register being associated with a second operational state of the consumption meter for metering flow of supplied liquid registered at a second pulse number of the flow meter unit, so that the consumption meter is capable of measuring legally verified consumption data for each of the at least first and second operational states;
   wherein the consumption meter is arranged for receiving an input and to set the operational state of the consumption meter based on the input in accordance with the arrangement of the flow meter unit at the consumer site, so as to store consumption values in the legally verified register associated with the set operational state of the consumption meter.

Moreover, with an alternative embodiment is provided a consumption meter arranged for fixed installation at a consumer site for measuring consumption data of either a hot or a cold supplied liquid to the consumer site, the meter comprises:
a flow meter unit arranged for mount at either an inlet side or an outlet side of the consumer site, and arranged for measuring a flow quantity of the supplied liquid;
an inlet temperature sensor for measuring an inlet temperature of the supplied liquid, and an outlet temperature sensor for measuring an outlet temperature of the supplied liquid;
a calculator unit configured to determine consumption values based on the flow quantity, the inlet temperature and the outlet temperature, wherein the calculator unit comprises at least a first and a second legally verified consumption registers for storing consumption values verified for billing, the first legally verified consumption register being associated with a first operational state of the consumption meter and the second legally verified consumption register being associated with a second operational state of the consumption meter, so that the consumption meter is capable of measuring legally verified consumption data for each of the at least first and second operational states;
   wherein the consumption meter is arranged for receiving an input and to set the operational state of the consumption meter based on the input in accordance with the arrangement of the flow meter unit at the consumer site, so as to store consumption values in the legally verified register associated with the set operational state of the consumption meter.

In the following, embodiments E1-E18 describe additional possible embodiments of the invention.

E1. A consumption meter arranged for fixed installation at a consumer site for measuring consumption data of either a hot or a cold supplied liquid to the consumer site, the meter comprises:
a flow meter unit arranged for mount at either an inlet side or an outlet side of the consumer site, and arranged for measuring a flow quantity of the supplied liquid;
an inlet temperature sensor for measuring an inlet temperature of the supplied liquid medium, and an outlet temperature sensor for measuring an outlet temperature of the supplied liquid medium;
a calculator unit configured to determine consumption values based on the flow quantity, the inlet temperature and the outlet temperature, wherein the calculator unit comprises at least two legally verified consumption registers for storing consumption values verified for billing; each legally verified consumption register being associated with an operational state of the consumption meter; so that the consumption meter is capable of measuring legally verified consumption data for each of the at least two operational states;
   wherein the consumption meter is arranged for obtaining an input at the consumer site and to determine the operational state of the consumption meter based on the input, and store consumption values for billing in a register which is legally verified for billing with the consumption meter in the determined operational state.

E2. The consumption meter according to E1, wherein the least two legally verified consumption registers for storing consumption values verified for billing comprises a first legally verified consumption register for consumed energy for inlet mount of the consumption meter and a second legally verified consumption register for consumed energy for outlet mount of the consumption meter.

E3. The consumption meter according to E1 or E2, wherein the least two legally verified consumption registers for storing consumption values verified for billing comprises a first legally verified consumption register for heat energy and a second legally verified consumption register for cooling energy.

E4. The consumption meter according to any of E1-E3, wherein the consumption meter comprises at least four legally verified consumption registers for storing consumption values verified for billing comprises a first legally verified consumption register for heat energy in inlet mount and a second legally verified consumption register for heat energy in outlet mount and a third legally verified consumption register for cooling energy in inlet mount and a fourth legally verified consumption register for cooling energy in outlet mount.

E5. The consumption meter according to any of E1-E4, wherein the consumption meter operates in accordance with a an operating flow direction, and wherein the consumption meter comprises at least one legally verified consumption register for storing consumption values verified for billing of the supplied liquid that flows in a direction which is opposite the operating flow direction.

E6. The consumption meter according to any of E1-E5, wherein in addition to storing consumption values for billing in a register in accordance with the determined operational state, consumption data is stored in at least one more legally verified consumption register of the at least two legally verified consumption registers which is not in accordance with the determined operational state.

E7. The consumption meter according to any of E1-E6, wherein two or more legally verified registers are associated with the operational state, wherein consumption values for billing is stored in at least one of the two or more associated registers based on a storage criterion.

E8. The consumption meter according to any of E1-E7, wherein at least one of the legally verified consumption registers for storing consumption values is imposed with an access constraint so that data can only be stored in the register upon fulfilment of the access constraint.

E9. The consumption meter according to any of E1-E8, wherein a first of the temperature sensors is mounted in a receiver site comprised in the same housing as the housing of the flow measuring unit, the meter temperature, and wherein a second of the temperature sensors is mounted in a receiver unit separate from the housing of the flow measuring unit, the other temperature.

E10. The consumption meter according to any of E1-E9, wherein the input obtained at the consumer site is determined based on an input of a user interface.

E11. The consumption meter according to any of E1-E10, wherein the input is determined by the calculator based on a measured input which fulfils a selection criterion.

E12. The consumption meter according to any of E1-E11, wherein the input obtained at the consumer site is determined based on a temperature difference between inlet temperature sensor and the outlet temperature sensor.

E13. The consumption meter according to any of E1-E12, wherein the input obtained at the consumer site is determined based on a temperature of the supplied liquid.

E14. The consumption meter according to any of E1-E13, wherein the consumption meter in a setup mode can be arranged to operate in any of the at least two operational states, and wherein the consumption meter upon termination of the setup mode is arranged to operate in a normal mode in a single operational state.

E15. The consumption meter according to E14, wherein the once the setup mode has been terminate, the operational state can only be change by breaking a physical seal of the consumption meter.

E16. The consumption meter according to E14 or E15, wherein the setup mode is terminated automatically by detecting a flow of a preselected amount of the supplied liquid medium.

E17. The consumption meter according to any of E1-E16, wherein the operational state is shown in a display of the consumption meter.

E18. The consumption meter according to any of E1-E17, wherein the flow meter unit is an ultrasonic flow meter arranged to measure a flow rate of the supplied liquid.

Although the present invention has been described in connection with the specified embodiments, it should not be construed as being in any way limited to the presented examples. The invention can be implemented by any suitable means; and the scope of the present invention is to be interpreted in the light of the accompanying claim set. Any reference signs in the claims should not be construed as limiting the scope.

1. A consumption meter arranged for fixed installation at a consumer site for measuring consumption data of either a hot or a cold supplied liquid to the consumer site, the meter comprises:
a flow meter unit arranged for mount at either an inlet side or an outlet side of the consumer site, and arranged for measuring a flow quantity of the supplied liquid;
an inlet temperature sensor for measuring an inlet temperature of the supplied liquid, and an outlet temperature sensor for measuring an outlet temperature of the supplied liquid; and
a calculator unit configured to determine consumption values based on the flow quantity, the inlet temperature and the outlet temperature, wherein the calculator unit comprises at least a first and a second legally verified consumption registers for storing consumption values verified for billing, the first legally verified consumption register being associated with a first operational state of the consumption meter being mounted at the inlet side of the consumer site and the second legally verified consumption register being associated with a second operational state of the consumption meter being mounted at the outlet side of the consumer site, so that the consumption meter is capable of measuring legally verified consumption data for each of the at least first and second operational states;
wherein the consumption meter is arranged for receiving an input and to set the operational state of the consumption meter based on the input in accordance with the arrangement of the flow meter unit at the consumer site, so as to store consumption values in the legally verified register associated with the set operational state of the consumption meter.

2-23. (canceled)

24. The consumption meter according to claim 1, wherein the consumption meter is further arranged for, in case an operational state of the consumption meter being inconsistent with the actual installation of the flow meter unit, receiving an additional input at the consumer site and to set the operational state of the consumption meter based on the input in accordance with the arrangement of the flow meter unit at the consumer site, so as to store consumption values in the legally verified register associated with the set operational state of the consumption meter.

25. The consumption meter according to claim 1, wherein the consumption meter comprises at least four legally verified consumption registers for storing consumption values verified for billing comprises a first legally verified consumption register for heat energy in inlet mount, and a second legally verified consumption register for heat energy in outlet mount, and a third legally verified consumption register for cooling energy in inlet mount, and a fourth legally verified consumption register for cooling energy in outlet mount.

26. The consumption meter according to claim 1, wherein the legally verified consumption registers are registers for flow of supplied liquid in a first flow direction, and for flow of the supplied liquid in a second, opposite flow direction.

27. The consumption meter according to claim 1, wherein the legally verified consumption registers are registers for flow of supplied liquid registered at a first pulse number of the flow meter unit, and for flow of supplied liquid registered at a second pulse number of the flow meter unit.

28. The consumption meter according to claim 1, wherein both of the first and the second legally verified consumption registers are arranged for storage of consumption values associated with the selected operational state of consumption meter.

29. The consumption meter according to claim 1, wherein the calculator unit comprises at least a third legally verified consumption register associated with the first or second operational state, wherein the consumption meter is arranged for storage of consumption values in the legally verified register associated with the selected operational state of the consumption meter as well as in the third legally verified consumption register.

30. The consumption meter according to claim 1, wherein the calculator unit comprises at least a third legally verified consumption register associated with the first or second operational state, wherein the consumption meter is arranged for storage of consumption values in the legally verified register associated with the selected operational state of the consumption meter or in the third legal legally verified consumption register based on a storage criterion.

31. The consumption meter according to claim 1, wherein at least one of the legally verified consumption registers for storing consumption values is imposed with an access constraint so that data can only be stored in the register upon fulfilment of the access constraint.

32. The consumption meter according to claim 1, wherein the flow meter unit comprises a flow meter unit housing, and wherein a first of the inlet and outlet temperature sensors is mounted in a receiver site comprised in the flow meter unit housing, and wherein a second of the inlet and outlet temperature sensors is mounted in a receiver unit separate from the flow meter unit housing.

33. The consumption meter according to claim 1, wherein the input to be received is received by the calculator unit and is based on a temperature difference between the inlet temperature and the outlet temperature.

34. The consumption meter according to claim 1, wherein the input to be received is received by the calculator unit and is based on a temperature of the supplied liquid.

35. The consumption meter according to claim 1, wherein the consumption meter is arranged for receiving the input while being in a set up mode, and once the setup mode has been terminated, to change the operational state only upon breaking a physical seal of the consumption meter.

36. The consumption meter according to claim 35, wherein the consumption meter is arranged for automatically terminating the setup mode by detecting a flow of a preselected amount of the supplied liquid.

37. A method for installation of a consumption meter arranged for fixed installation at a consumer site for measuring consumption data of either a hot or a cold supplied liquid to the consumer site,
wherein the meter comprises:
a flow meter unit arranged for mount at either an inlet side or an outlet side of the consumer site, and arranged for measuring a flow quantity of the supplied liquid;
an inlet temperature sensor for measuring an inlet temperature of the supplied liquid, and an outlet temperature sensor for measuring an outlet temperature of the supplied liquid; and
a calculator unit configured to determine consumption values based on the flow quantity, the inlet temperature and the outlet temperature, wherein the calculator unit comprises at least a first and a second legally verified consumption registers for storing consumption values verified for billing, the first legally verified consumption register being associated with a first operational state of the consumption meter being mounted at the inlet side of the consumer site and the second legally verified consumption register being associated with a second operational state of the consumption meter being mounted at the outlet side of the consumer site; and
wherein the method comprises:
arranging the flow meter unit at either an inlet side or an outlet side of the consumer site; and
providing an input to be received by the consumption meter, to select, between the at least first and second operational states of the consumption meter, the operational state of the consumption meter in accordance with the arrangement of the flow meter unit at the consumer site so as to store consumption values in the legally verified register associated with the selected operational state of the consumption meter.
